(19) United States
(12) Patent Application Publication
(10) Pub. No.: US 2002/0127526 A1
(43) Pub. Date: Sep. 12, 2002

(54) Vacation simulation system

(76) Inventor: Roger Hruska, Johnsburg, IL (US)

Correspondence Address: Richard W. Goldstein, 2071 Clove Road, Staten Island, NY, 10304, US

(21) Appl. No.: 09/733,496

(22) Filed: Dec. 8, 2000

Related U.S. Application Data
(60) Provisional application No. 60/169,647, filed on Dec. 8, 1999.

(51) Int. Cl. G09B 5/00

(52) U.S. Cl. 434/307 R

(57) ABSTRACT

A vacation simulation system including a DVD player adapted for receiving individual DVD's. Each individual DVD includes simulations of a vacation location thereon. The simulations include background noises related to the vacation location. Each individual DVD has a running time of about thirty minutes. A headset is provided that is adapted for positioning over eyes and ears of the person. The headset is in communication with the DVD player whereby the simulations from the individual DVD's can be seen and heard through the headset. An aroma emitting device is provided that is adapted for emitting a variety of aromas therefrom. The aroma emitting device is in communication with the DVD player whereby the variety of aromas will correspond with the simulations.

### BACKGROUND OF THE INVENTION

The present invention relates to a vacation simulation system and more particularly pertains to simulating a vacation for a person.

The use of virtual reality systems is known in the prior art. More specifically, virtual reality systems heretofore devised and utilized for the purpose of simulating certain events are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,696,521 to Robinson discloses a headset system capable of displaying three dimensional video and surround sound audio to the user for various virtual reality applications. U.S. Pat. No. 5,712,649 to Tosaki discloses head mounted goggles capable of displaying an image from a variety of sources including video or from a computer. U.S. Pat. No. 5,767,820 to Bassett discloses a head mounted display system for use in a virtual reality system using a variety of video sources.

While these devices fulfill their respective, particular objective and requirements, the aforementioned patents do not describe a vacation simulation system for simulating a vacation for a person.

In this respect, the vacation simulation system according to the present invention substantially departs from the conventional concepts and designs of the prior art, and in doing so provides an apparatus primarily developed for the purpose of simulating a vacation for a person.

Therefore, it can be appreciated that there exists a continuing need for a new and improved vacation simulation system which can be used for simulating a vacation for a person. In this regard, the present invention substantially fulfills this need.

### SUMMARY OF THE INVENTION

In the view of the foregoing disadvantages inherent in the known types of virtual reality systems now present in the prior art, the present invention provides an improved vacation simulation system. As such, the general purpose of the present invention, which will be described subsequently in greater detail, is to provide a new and improved vacation simulation system which has all the advantages of the prior art and none of the disadvantages.

To attain this, the present invention essentially comprises a DVD player adapted for receiving individual DVD's. Each individual DVD includes simulations of a vacation location thereon. The simulations include background noises related to the vacation location. Each individual DVD has a running time of about thirty minutes. A headset is provided that is adapted for positioning over eyes and ears of the person. The headset is in communication with the DVD player whereby the simulations from the individual DVD's can be seen and heard through the headset. An aroma emitting device is provided that is adapted for emitting a variety of aromas therefrom. The aroma emitting device is in communication with the DVD player whereby the variety of aromas will correspond with the simulations.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved vacation simulation system which has all the advantages of the prior art virtual reality systems and none of the disadvantages.

It is another object of the present invention to provide a new and improved vacation simulation system which may be easily and efficiently manufactured and marketed.

It is a further object of the present invention to provide a new and improved vacation simulation system which is of durable and reliable construction.

An even further object of the present invention is to provide a new and improved vacation simulation system which is susceptible of a low cost of manufacture with regard to both materials and labor, and which accordingly is then susceptible of low prices of sale to the consuming public, thereby making such a vacation simulation system economically available to the buying public.

Even still another object of the present invention is to provide a new and improved vacation simulation system for simulating a vacation for a person.

Lastly, it is an object of the present invention to provide a new and improved vacation simulation system including a DVD player adapted for receiving individual DVD's. Each individual DVD includes simulations of a vacation location thereon. The simulations include background noises related to the vacation location. Each individual DVD has a running time of about thirty minutes. A headset is provided that is adapted for positioning over eyes and ears of the person. The headset is in communication with the DVD player whereby the simulations from the individual DVD's can be seen and heard through the headset. An aroma emitting device is provided that is adapted for emitting a variety of aromas therefrom. The aroma emitting device is in communication with the DVD player whereby the variety of aromas will correspond with the simulations.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the headset of the vacation simulation system constructed in accordance with the principles of the present invention.

FIG. 2 is a perspective of the aroma emitting device of the present invention.

FIG. 3 is a perspective view of the present invention illustrated in use.

The same reference numerals refer to the same parts through the various figures.

### DESCRIPTION OF THE PREFERRED EMBODIMENT

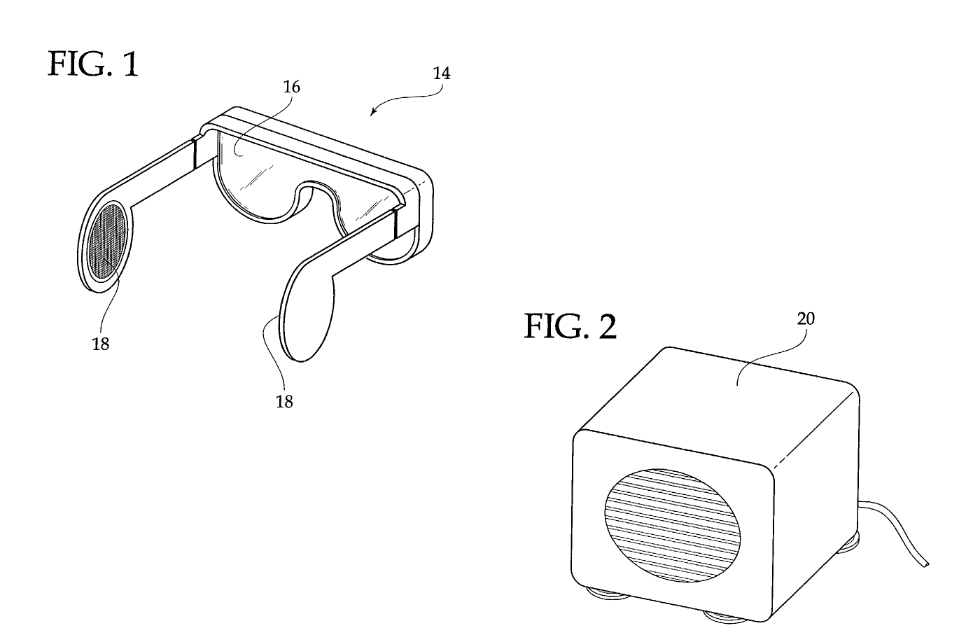

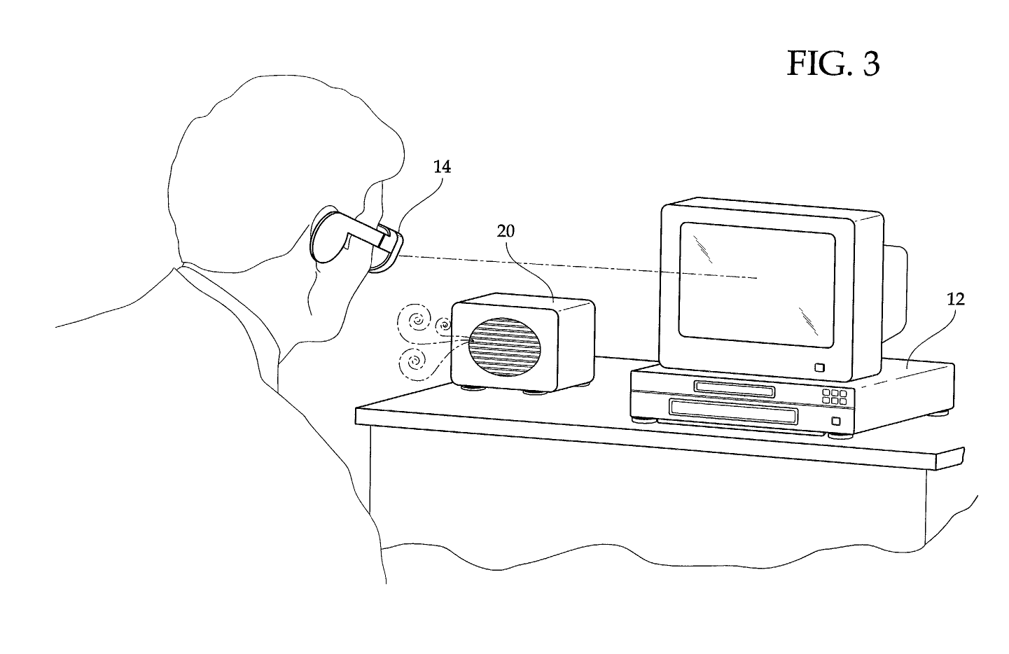

With reference now to the drawings, and in particular, to FIGS. 1 through 3 thereof, the preferred embodiment of the new and improved vacation simulation system embodying the principles and concepts of the present invention and generally designated by the reference number 10 will be described.

Specifically, it will be noted in the various Figures that the device relates to a vacation simulation system for simulating a vacation for a person. In its broadest context, the device consists of a DVD player, a headset, and an aroma emitting device. Such components are individually configured and correlated with respect to each other so as to attain the desired objective.

The DVD player 12 is adapted for receiving individual DVD's. Alternately, a video cassette recorder could be used with corresponding video cassettes. Each individual DVD includes simulations of a vacation location thereon. The simulations would include popular sites associated with particular vacation locations. The simulations include background noises related to the vacation location. The background noises would include, but are not limited to, the sound of the surf and seagulls for a beach location. Each individual DVD has a running time of about thirty minutes. The running time can be varied according to the application. For commercial settings, the running times would be shorter whereas a longer running time for use at home would be preferable.

The headset 14 is adapted for positioning over eyes and ears of the person. Note FIG. 1. The headset 12 is in communication with the DVD player 12 whereby the simulations from the individual DVD's can be seen and heard through the headset 14. The headset 14 is provided with a viewing screen 16 and a pair of speakers 18.

The aroma emitting device 20 is adapted for emitting a variety of aromas therefrom. Note FIG. 2. The aroma emitting device 20 is in communication with the DVD player 12 whereby the variety of aromas will correspond with the simulations.

As to the manner Qf usage and operation of the present invention, the same should be apparent from the above description.

Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A vacation simulation system for simulating a vacation for a person comprising, in combination:
a DVD player adapted for receiving individual DVD's, each individual DVD including simulations of a vacation location thereon, the simulations including background noises related to the vacation location, each individual DVD having a running time of about thirty minutes;
a headset adapted for positioning over eyes and ears of the person, the headset being in communication with the DVD player whereby the simulations from the individual DVD's can be seen and heard through the headset;
an aroma emitting device adapted for emitting a variety of aromas therefrom, the aroma emitting device being in communication with the DVD player whereby the variety of aromas will correspond with the simulations.
